(19) United States
(12) Patent Application Publication
(10) Pub. No.: US 2003/0014486 A1
(43) Pub. Date: Jan. 16, 2003

(54) Distributed audio network using networked computing devices

(76) Inventor: Gregory J. May, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/906,512

(22) Filed: Jul. 16, 2001

(51) Int. Cl. H04M 11/04; H04B 3/00; G06F 15/16

(52) U.S. Cl. 709/204; 381/77; 340/310.02

(57) ABSTRACT

A sound system includes a plurality of computing systems distributed within a performance area. Each computing system includes a speaker, and a processor. The processor oversees audio data being played as sound on the speaker. A controller provides coordination of the performance of the audio data on the computing systems. Audio effects are achieved by varying timing and/or content of audio data played as sound on the speakers as overseen by the processor within each computing system.

### BACKGROUND

The present invention pertains to networking of computing systems and pertains particularly to a distributed audio network using networked computing devices.

In classrooms throughout the United States and other countries, computers are increasingly popular. Many students carry notebook computers with them to class. Some classes include a desktop computer at every student station. These computers can be networked together using, for example, wires, optical signals or radio frequency signals.

When receiving information (e.g. through a microphone) it is often desirable to avoid feedback. For example, some speaker phones used in conference rooms send a pulse and set up echo cancellation to avoid feedback.

Placement of multiple speakers within a room allows the use of many audio effects. For example, movie theatres use different sound tracks to produce sound effects such as surround sound. Thus, it is desirable to make use of an arrangement of computing devices to produce a distributed audio effect.

### SUMMARY OF THE INVENTION

In accordance with a preferred embodiment of the present invention, a sound system includes a plurality of computing systems distributed within a performance area. Each computing system includes a speaker, and a processor. The processor oversees audio data being played as sound on the speaker. A controller provides coordination of the performance of the audio data on the computing systems. Audio effects are achieved by varying timing and/or content of audio data played as sound on the speakers as overseen by the processors within the plurality of computing systems.

### BRIEF DESCRIPTION OF THE DRAWINGS

FIG. 1 is a simplified diagram showing computers networked together in a classroom or other room in accordance with a preferred embodiment of the present invention.

FIG. 2 is a simplified functional block diagram of one of the portable computers shown in FIG. 1.

### DESCRIPTION OF THE PREFERRED EMBODIMENT

In a preferred embodiment of the present invention, a sound system includes a plurality of computing systems distributed within a performance area. Each computing system includes a speaker, and a processor. The processor oversees audio data being played as sound on the speaker. A controller provides coordination of the performance of the audio data on the computing systems. Audio effects are achieved by varying timing and/or content of audio data played as sound on the speakers as overseen by the processors within the plurality of computing systems.

For example, when the audio effect is a stereo effect within the performance area, a first track of audio data is played by speakers within a first set of computing systems in a first geographic location within the performance area. A second track of audio data is played by speakers within a second set of computing systems in a second geographic location within the performance area. Other audio effects such as surround sound or an echoing effect can also be implemented within the performance area. A performance of audio data through the speakers can also be for the purpose of noise cancellation of sounds used to silence background noise in the performance area

The sound system can also include additional speakers controlled directly by the controller. Also, each computing system in the plurality of computing system may include a second speaker.

During an audio performance, for example, the controller transfers to each of the computing systems audio data representing channels of audio information. Alternatively, audio data is pre-loaded into each of the computing systems before an audio performance directed by the controller.

In one preferred embodiment of the invention, each computing system additionally includes a microphone. The microphones within the computing systems are used by the processors within the computing systems to sample audio signals. The sampled audio signals are used to provide audio feedback information to the controller. For example, the processors with the computing systems process the sampled audio signals to produce the feedback information. Alternatively, the feedback information sent to the controllers is unprocessed sampled audio signal. Alternatively, stand-alone microphones (not inside a computing system) can be used in addition to or instead of microphones within computing systems.

The controller uses the feedback information, for example, to make real time adjustments to sound being played on the speakers. Alternatively, or in addition, the controller uses the feedback information to perform a calibration before an audio performance is performed. The microphones within the computing systems can also be used to process audio signals. The processed audio signals are used to provide additional audio data to be played as sound on the speakers.

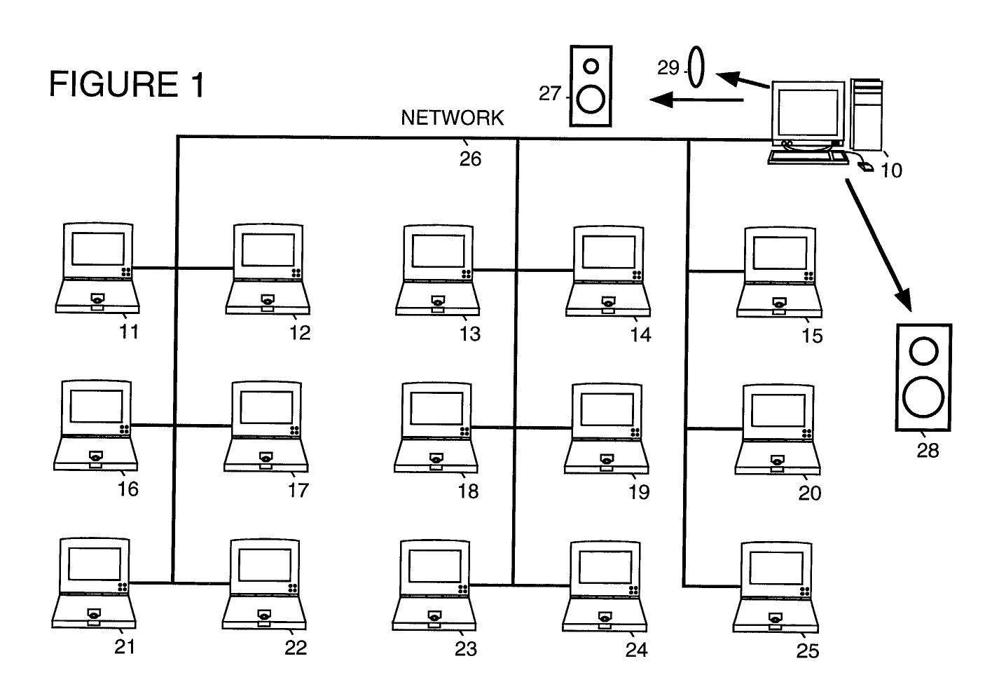

FIG. 1 shows a computer 10, a computer 11, a computer 12, a computer 13, a computer 14, a computer 15, a computer 16, a computer 17, a computer 18, a computer 19, a computer 20, a computer 21, a computer 22, a computer 23, a computer 24 and a computer 25 connected together via a network 26. Network 26 is, for example, a local area network implemented using wires, optical signals or radio frequency signals. Alternatively, network 26 can be any form of wire or wireless links between computer 10 and computers 11 through 25 that allows data transfer between computer 10 and computers 11 through 25.

Computer 10 functions as a controller for the sound system consisting of speakers within computers 11 through 25. Alternatively, any computer in the network can function as a controller for the sound system.

Computers 10 through 25 are located in a performance area. For example, a performance area is a classroom, an indoor auditorium or even an outdoor auditorium. By way of example, computers 11 through 25 are shown to be notebook computers and computer 10 is shown as a desktop model. This is merely exemplary as computers 10 through 25 can include a mixture of any type of computing systems where each computing system includes a speaker. A computing system is any device with computing capability. For example, a computing system can be a desktop computer, a notebook computer, personal digital assistant, a cellular telephone that includes a processor, a pager that includes a processor, and any other type of entity with a processor.

In the example shown in FIG. 1, computer 10 is used to coordinate audio signals played by computers 11 through 25. This takes advantage of connection of computer 10 to computers 11 through 25 and the geographic distribution of computers 11 through 25 within a performance area. For example, this can allow computer 10 to simulate theater effects using speakers within computers 11 through 25.

For example, when the locations of computers 11 through 25 are within known locations with respect to one another, computer 10 is able to intelligently apply phase shifts or alternate sound tracks to coordinate audio signals to produce audio effects within the performance area. This is done, for example, by altering audio data stream being downloaded to computers 11 through 25, or by issuing commands concerning playback of audio data stored within computers 11 through 25. This can also be done, for example, by each of computers 11 through 25 based on its knowledge of its own location. Use of the individual speakers within computers 11 through 25 in a coordinated fashion results in a massive distributive speaker network within the performance area.

For example, within a classroom layout, computers 11 through 25 are student notebook computers placed on every student desk. Each notebook computer has at least one speaker but most often has two stereo speakers. Since the location of the desks are known, the approximate locations of the speakers within computers 11 through 25 are known by computer 10. More accurate location of the speakers can be guaranteed if computers 11 through 25 are identical models placed in a known location and orientation at student stations. For example, computer 10 can track locations of computers 11 through 25 with the use of a mapping program. When the locations of any of computers 11 through 25 changes, adjustments can be made to audio data to compensate for any changes in location. The adjustments to audio data can be initiated by computer 10 or by computers 11 through 25.

Alternatively or in addition to use of a mapping program, a calibration process can be used to feed back to computer 10 information about the location of computers 11 through 25 and their audio capability. This calibration described more fully below can be used to adjust speakers to dynamically “fill in” the space with sound with respect to a particular user or location in the performance area. The calibration described more fully below also can be used to make adjustments and compensations for differences in speaker performances, etc. within computers 11 through 25.

For example, if all that is desired is stereo sound, the computers on one side of the performance area can present the left side stereo portion and computers on the other side of the performance area can present the right side stereo portion. More advanced processing such as surround sound information can be presented to each bank or set of computers at their locations such that the overall effect is like the sound within a large theatre.

Additional speakers (represented in FIG. 1 by a wireless speaker 27 and a wireless speaker 28) can be added, for example, as a base response unit to fill in the heavy sounds that might not be adequately supported by small notebook speakers. Likewise, additional microphones (represented in FIG. 1 by a wireless microphone 29) can be added, to provide more locations for receiving sound (or, for improved sound reception).

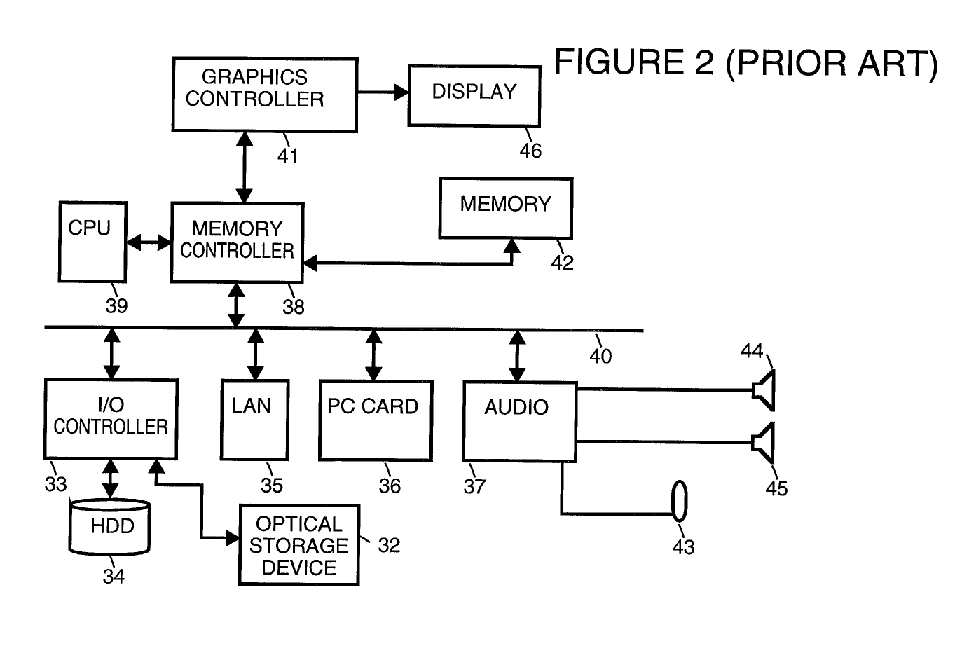

FIG. 2 is a simplified exemplary block diagram of any of computers 10 through 25. Connected to an input/output (I/O) bus 40 is an I/O controller 33, a local area network (LAN) interface 35, a PC card interface 36, an audio interface 37 and a memory controller 38. Other entities may be connected to I/O bus 40 as well. Audio interface 37 is shown connected to a speaker 44, a speaker 45 and a microphone 43.

I/O controller 33 is connected to a hard disk drive (HDD) 34 and an optical storage device 32. For example, optical storage device 32 is a compact disc (CD) storage device, or a digital video disc (DVD) storage device. Memory controller 38 is connected to a central processing unit (CPU) 39, a graphics controller 41 and memory 42. Memory 42 is, for example composed of dynamic RAM (DRAM). Graphics controller 41 controls a display 46.

In order to utilize speakers within computers 11 through 25, audio data is received by computers 11 through 25. Audio data is data used by computers 11 through 25 in production of sound played on one or more speakers. Depending on the bandwidth capability of the wired or wireless links many methods can be used to transfer the audio data to computers 11 through 25. For example, audio data representing channels of audio information can be transferred to each of computers 11 through 25 during playback of the audio information. This works best when the data transfer bandwidth of network 26 is high and there are a limited number of audio channels used by computers 11 through 25 for a performance.

Alternatively, before an audio performance, audio data is pre-loaded into each of computers 11 through 25. This pre-loading can be done through network 26 or through other means, for example by placement of on individual DVD or CDs run on each of computers 11 through 25. During performance, for example, each of computers 11 through 25 is assigned a track or channel to process. During an audio performance, computers 11 through 25 are synchronized. This is done, for example by precise synchronization of clocks within computers 11 through 25 or by use of timing signals sent from computer 10 or one of computers 11 through 25.

Alternatively, one or more of computers 11 through 25 can each play the same audio data, however, with delayed start times to accomplish particular effects. For example, each of computers 11 through 25 recognizes its location and based on this knowledge of location is able to extract the surround sound information from audio data stored within the computer or from audio data transferred over network 26. Instead, of or in addition to, the transfer of audio data for each individual channel, the difference between channels or the sum of the channels can be transferred. Additional calibration information can be utilized by each of computers 11 through 25 to account for the acoustics of the performance area. In this case, the control function performed by computer 10 (or another computer on the network) is used for start/stop timing and network synchronization. Calibration information can be used, for example, by each of computers 11 through 25 to take standard information from an audio/digital track and make adjustment (e.g. phase delays, frequency, filtering or equalizing) in order to produce various acoustic effects.

Application of the appropriate delays allows simulation of the acoustics of a concert hall, music in a canyon, or any number of desired effects. MIDI information can be utilized to simulate an orchestra, each of computers 11 through 25 being assigned a track or an instrument.

In a preferred embodiment of the present invention, microphones within computers 11 through 25 can be used for calibrating performance area response and theater effects. Using microphones within computers 11 through 25 allows computer 10 to use network 26 to sample audio signals from various locations in the performance area and adjust sound levels and frequency response to improve or calibrate the performance area audio response of a presentation. For example, the performance area audio response results from the echoes and sound levels of the various audio components of the sound system. Existing microphones within computers 11 through 25 sample the sound at the location of computers 11 through 25 and feed the sampled data back through network 26 to computer 10.

Processing of the sampled audio is done by each of computers 11 through 25 before transferring the processed information to computer 10. Alternatively, computers 11 through 25 send to computer 10 raw sampled audio that is processed by computer 10. Computer 10 uses the processed data, for example, to make real time adjustments to sound being played by computers 11 through 25 and any other speakers in the sound system. This is done, for example by altering audio data stream being downloaded to computers 11 through 25, or by issuing commands concerning playback of audio data stored within computers 11 through 25. This can be done also in order to adjust for network processing delays and other delays. Delays can occur, for example, because of the time it takes to send commands to each computer and for each computer to process data before the data is applied. Delays can also occur, for example, because of the time it takes to read data from a CD/DVD as each CD will be at different rotation positions. Processing time can be calibrated out as well by positioning the order in which data is sent to each of computers 11 through 25. For example, a particularly slow processing computer may need to receive data earlier than a computer that is able to process data faster. This help take into account significantly different processing capabilities (e.g., between a palm pilot and a Pentium IV based machine) among computers 11 through 25.

When audio data stream is used, a dedicated network is helpful as additional network traffic may affect the quality of a performance. However, in some cases this can be overcome with appropriate pipelining/buffering techniques known in the art or by increasing bandwidth of the network.

Computers 11 through 25 can also take standard information from an audio/digital track and apply adjustments (e.g., phase delays, frequency filtering and/or equalizing). To do this, computers 11 through 25 can apply information stored, commands given from computer 10 and/or using calibration factors.

For example, pulses or known audio frequencies are generated by speakers within computers 11 through 25 and any other stand-alone speakers used within the system. Microphones within computers 11 through 25 are used to measure response. For example, calibration is performed before an audio performance is begun. Alternatively, calibration is ongoing during an audio performance using audio sound generated as part of the audio performance. For example, received sound can compared to master data (time or frequency response) stored in computer 10. In the preferred embodiment, there are no feedback issues as sampled audio data is not replayed.

In a classroom application, microphones within computers 11 through 25 are used to allow each student the ability to respond to an instructor. This information is received by computer 10 and rebroadcast through the sound system consisting of the speakers within computers 11 through 25 and any other additional speakers. In this case, it is necessary to use known phasing and inversion techniques to correct any feedback effects. In one embodiment of the present invention, each of computers 11 through 25 is used to process data received by its own microphone environment to filter out fan/hard drive noise and so on, before transferring audio data to computer 10. This is done, for example, using known techniques to calibrate out noise by sampling sound detected by the microphone for the computer, searching for noise patterns that are then inverted and added to audio data received by the microphone within the computer.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A sound system comprising:
a plurality of computing systems distributed within a performance area, each computing system including:
a speaker, and
a processor that oversees audio data being played as sound on the speaker; and,
a controller for providing coordination of the performance of the audio data on the computing systems, wherein audio effects are achieved by varying at least one of timing and content of audio data played as sound on the speakers as overseen by the processor within each computing system.

2. A sound system as in claim 1 wherein each computing system in the plurality of computing system additionally includes a second speaker.

3. A sound system as in claim 1 wherein the audio effect is a stereo effect within the performance area where a first track of audio data is played by speakers within a first set of computing systems in a first geographic location within the performance area and a second track of audio data is played by speakers within a second set of computing systems in a second geographic location within the performance area.

4. A sound system as in claim 1 wherein the audio effect is a surround sound effect within the performance area.

5. A sound system as in claim 1 wherein the audio effect is an echoing sound effect within the performance area.

6. A sound system as in claim 1 additionally comprising:
additional speakers controlled directly by the controller.

7. A sound system as in claim 1 wherein the controller transfers to each of the computing systems audio data representing channels of audio information.

8. A sound system as in claim 1 wherein audio data is pre-loaded into each of the computing systems before an audio performance directed by the controller.

9. A sound system as in claim 8 wherein the audio data is pre-loaded into an optical storage device within each of the computing systems.

10. A sound system as in claim 1 wherein each computing system additionally comprises a microphone, the microphone within each computing system being used by the processor within each computing system to sample audio signals, the sampled audio signals being used to provide audio feedback information to the controller.

11. A sound system as in claim 10 wherein the processor within each computing system processes the sampled audio signals to produce the feedback information.

12. A sound system as in claim 10 wherein the feedback information is unprocessed sampled audio signal.

13. A sound system as in claim 10 wherein the controller uses the feedback information to make real time adjustments to sound being played on the speakers.

14. A sound system as in claim 10 wherein the controller uses the feedback information to perform a calibration before an audio performance is performed using the speaker within each computing system.

15. A sound system as in claim 1 wherein each computing system additionally comprises a microphone, the microphone within each computing system being used to capture audio signals which are processed by the processor within each computing system, the processed audio signals being used to provide additional audio data to be played as sound on the speakers.

16. A sound system as in claim 15, wherein the processed audio signals are processed by the processor within each computing system to filter out noise.

17. A sound system as in claim 1 wherein coordination provided by the controller includes synchronization of the computing systems.

18. A sound system as in claim 1 wherein the controller comprises a computing system that is also used in performance of the audio data.

19. A sound system as in claim 1 additionally comprising microphones used to sample audio signals, the sampled audio signals being used to provide audio feedback information to the controller.

20. A sound system comprising:
a plurality of speakers;
a plurality of computing systems distributed within a performance area, each computing system including:
a processor, and
a microphone, the microphone being used by the processor to sample audio signals, the sampled audio signals being used to provide audio feedback information; and,
a controller for receiving the audio feedback information and providing coordination of the performance of audio data through the speakers.

21. A sound system as in claim 20 wherein the speakers are located within the computing systems so that each computing system in the plurality of computing systems includes at least one of the speakers.

22. A sound system as in claim 20 wherein the processor within each computing system processes the sampled audio signals to produce the feedback information.

23. A sound system as in claim 20 wherein the feedback information is unprocessed sampled audio signal.

24. A sound system as in claim 20 wherein the controller uses the feedback information to make real time adjustments to sound being played on the speakers.

25. A sound system as in claim 20 wherein the controller uses the feedback information to perform a calibration before an audio performance is performed using the speakers.

26. A sound system as in claim 20 wherein the processor within each computing system additionally processes audio signals received from the microphone, the processed audio signals being used to provide additional audio data to be played as sound on the speakers.

27. A sound system as in claim 26, wherein the processed audio signals are processed by the processor within each computing system to filter out noise.

28. A sound system as in claim 20 wherein the performance of the audio data through the speakers is noise cancellation sounds used to silence background noise in the performance area.

29. A sound system comprising:
a plurality of speakers;
a plurality of computing systems distributed within a performance area, each computing system including:
a processor, and
a microphone, the microphone being used by the processor to process audio signals received from the microphone; and,
a controller that provides coordination of the performance of audio data as sound through the speakers, the controller receiving the processed audio data and including the processed audio data with the audio data played as sound through the speakers.

30. A sound system as in claim 29 wherein the speakers are located within the computing systems so that each computing system in the plurality of computing systems includes at least one of the speakers.

31. A sound system as in claim 29, wherein the processed audio signals are processed by the processor within each computing system to filter out noise.

32. A sound system as in claim 29, wherein the processed audio signals are processed by the controller to filter out noise.

33. A method comprising the following:
(a) distributing a plurality of computing systems within a performance area, each computing system including a speaker; and,
(b) producing an audio performance using the speaker within each computing system, including the following substep:
(b.1) providing coordination of the audio performance in order to produce audio effects, the audio effects being achieved by varying at least one of timing and content of audio data played as sound on at least one of the speakers within at least one of the computing systems.

34. A method as in claim 33 additionally comprising the following:
(c) including within each computing system a microphone;
(d) using the microphone within each computing system to sample audio signals; and,
(e) using the sampled audio signals to provide audio feedback information to be used in producing the audio performance.

35. A method comprising the following:
(a) distributing a plurality of computing systems within a performance area, each computing system including a microphone;
(b) using the microphone within each computing system to sample audio signals; and,
(c) using the sampled audio signals to provide audio feedback information to be used in producing an audio performance.

36. A method comprising the following:
(a) distributing a plurality of computing systems within a performance area, each computing system including a microphone;
(b) using the microphone within each computing system to process audio signals received from the microphone; and,
(c) including the processed audio data with audio data played during an audio performance.

37. A method as in claim 36 wherein the audio performance is noise cancellation sounds used to silence background noise in the performance area.
